(19) United States
(12) Patent Application Publication
(10) Pub. No.: US 2025/0124665 A1
(43) Pub. Date: Apr. 17, 2025

(54) MIXED REALITY DEVICE, DISPLAY CONTROL METHOD, AND STORAGE MEDIUM

(71) Applicant: KABUSHIKI KAISHA TOSHIBA, Tokyo (JP)

(72) Inventors: Hiroki SHINAGAWA, Yokohama Kanagawa (JP); Sumire NISHIJIMA, Kodaira Tokyo (JP); Yukino MASUI, Yokohama Kanagawa (JP); Takanori YOSHII, Kawasaki Kanagawa (JP); Kyotaro HAYASHI, Yokohama Kanagawa (JP); Hiroaki NAKAMURA, Kawasaki Kanagawa (JP); Yoshiyuki HIRAHARA, Mishima Shizuoka (JP); Masamitsu FUKUDA, Yokohama Kanagawa (JP); Takehiro KATO, Yokohama Kanagawa (JP); Takafumi KOZAKAI, Ota Tokyo (JP); Yasuo NAMIOKA, Nerima Tokyo (JP)

(21) Appl. No.: 18/910,707

(22) Filed: Oct. 9, 2024

(30) Foreign Application Priority Data
Oct. 11, 2023 (JP) 2023-176197

(51) Int. Cl. G06T 19/00

(52) U.S. Cl. CPC G06T 19/003; G06T 19/006

(57) ABSTRACT

According to one embodiment, a mixed reality device is capable of superimposing a virtual space on a real space. The mixed reality device is configured to set a three-dimensional coordinate system in the virtual space based on a prescribed object imaged in the real space. The mixed reality device is further configured to display a virtual object at a predetermined position in the three-dimensional coordinate system. The mixed reality device is further configured to change a display direction of the virtual object according to a positional relationship between the virtual object and the mixed reality device.

### CROSS-REFERENCE TO RELATED APPLICATIONS

This application is based upon and claims the benefit of priority from Japanese Patent Application No.2023-176197, filed on Oct. 11, 2023; the entire contents of which are incorporated herein by reference.

### FIELD

Embodiments of the present invention generally relate to a mixed reality device, a display control method, and a storage medium

### BACKGROUND

There are mixed reality devices that display virtual space superimposed on real space. There is a need for technology that can improve the usability of this mixed reality device.

### BRIEF DESCRIPTION OF THE DRAWINGS

FIG. 1 is a schematic view illustrating a mixed reality device according to a first embodiment;

FIG. 2 is a schematic view illustrating a state of the real space;

FIG. 3 is a schematic view illustrating a display example by the mixed reality device according to the first embodiment;

FIG. 4 is a schematic view illustrating a display example by the mixed reality device according to the first embodiment;

FIGS. 5A and 5B are schematic views illustrating display examples by the mixed reality device according to the first embodiment;

FIG. 6 is a schematic view for explaining processing by the mixed reality device according to the first embodiment;

FIGS. 7A and 7B are schematic views for explaining processing by the mixed reality device according to the first embodiment;

FIG. 8 is a flowchart illustrating a display control method by the mixed reality device according to the first embodiment;

FIG. 9 is a schematic view illustrating a display example by the mixed reality device according to the first embodiment;

FIG. 10 is a schematic view illustrating a display example by the mixed reality device according to the first embodiment;

FIG. 11 is a schematic view illustrating a display example by a mixed reality device according to the second embodiment;

FIG. 12 is a schematic view illustrating a display example by the mixed reality device according to the second embodiment;

FIG. 13 is a schematic view for explaining processing by the mixed reality device according to the second embodiment;

FIG. 14 is a schematic view for explaining processing by the mixed reality device according to the second embodiment;

FIG. 15 is a schematic view for explaining processing by the mixed reality device according to the second embodiment;

FIGS. 16A to 16C are schematic views for explaining processing by the mixed reality device according to the second embodiment;

FIG. 17 is a schematic view for explaining processing by the mixed reality device according to the second embodiment;

FIGS. 18A and 18B are schematic views for explaining processing by the mixed reality device according to the second embodiment;

FIG. 19 is a flowchart illustrating a display control method by the mixed reality device according to the second embodiment;

FIG. 20 is a schematic view illustrating a display example by the mixed reality device according to the embodiment;

FIG. 21 is a schematic view illustrating a display example by the mixed reality device according to the embodiment;

FIG. 22 is a schematic view illustrating a state of a task;

FIGS. 23A and 23B are schematic views illustrating display examples by the mixed reality device according to the embodiment;

FIG. 24 is a schematic view for explaining processing by the mixed reality device according to the embodiment;

FIGS. 25A and 25B are schematic views illustrating display examples by the mixed reality device according to the embodiment;

FIGS. 26A and 26B are schematic views illustrating display examples by the mixed reality device according to the embodiment;

FIG. 27 is a schematic view illustrating a display example by the mixed reality device according to the embodiment;

FIG. 28 is a flowchart illustrating a processing method by the mixed reality device according to the embodiment; and

FIG. 29 is a schematic diagram illustrating a hardware configuration.

### DETAILED DESCRIPTION

According to one embodiment, a mixed reality device is capable of superimposing a virtual space on a real space. The mixed reality device is configured to set a three-dimensional coordinate system in the virtual space based on a prescribed object imaged in the real space. The mixed reality device is further configured to display a virtual object at a predetermined position in the three-dimensional coordinate system. The mixed reality device is further configured to change a display direction of the virtual object according to a positional relationship between the virtual object and the mixed reality device.

Embodiments of the invention will now be described with reference to the drawings. The drawings are schematic or conceptual; and the relationships between the thicknesses and widths of portions, the proportions of sizes between portions, etc., are not necessarily the same as the actual values thereof. The dimensions and/or the proportions may be illustrated differently between the drawings, even in the case where the same portion is illustrated. In the drawings and the specification of the application, components similar to those described thereinabove are marked with like reference numerals, and a detailed description is omitted as appropriate.

### First Embodiment

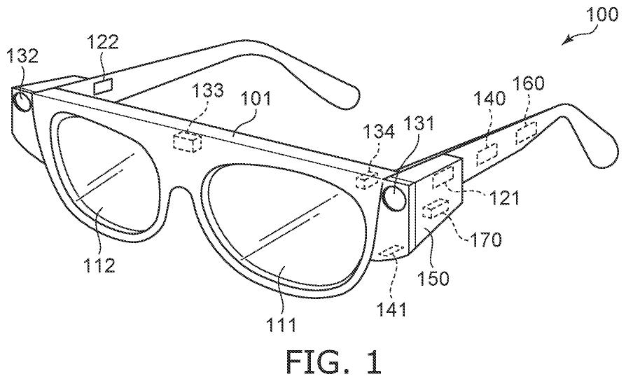

FIG. 1 is a schematic view illustrating a mixed reality device according to a first embodiment.

A first embodiment of the present invention relates to a mixed reality device (MR device). For example, as shown in FIG. 1, the MR device 100 according to the first embodiment includes a frame 101, a lens 111, a lens 112, a projection device 121, a projection device 122, an image camera 131, a depth camera 132, a light source 133, an eye-tracking camera 134, a sensor 140, a microphone 141, a processing device 150, a battery 160, and a storage device 170.

In the illustrated example, the MR device 100 is a binocular-type head-mounted display. Two lenses 111 and 112 are embedded in the frame 101. The projection devices 121 and 122 project information onto lenses 111 and 112, respectively.

The projection device 121 and the projection device 122 display the detection result of the worker's body, a virtual object, etc. on the lens 111 and the lens 112. Only one of the projection device 121 and the projection device 122 may be provided, and information may be displayed on only one of the lens 111 and the lens 112.

The lens 111 and the lens 112 are transparent. The worker can see the real-space environment through the lens 111 and the lens 112. The worker can also see the information projected onto the lens 111 and the lens 112 by the projection device 121 and the projection device 122. The projections by the projection device 121 and the projection device 122 display information overlaid on the real space.

The image camera 131 detects visible light and acquires a two-dimensional image. The depth camera 132 emits infrared light and acquires a depth image based on the reflected infrared light. The light source 133 irradiates light (e.g., infrared light) toward the wearer's eyeball. The eye-tracking camera 134 detects the light reflected by the wearer's eyeball. The sensor 140 is a 6-axis detection sensor, and can detect 3-axis angular velocity and 3-axis acceleration. The microphone 141 accepts voice input.

The processing device 150 controls each element of the MR device 100. For example, the processing device 150 controls the display by the projection device 121 and the projection device 122. Hereinafter, the processing device 150 causes the projection devices 121 and 122 to display information on lenses 111 and 112, which is also simply referred to as “the processing device displays information.” Additionally, the processing device 150 detects the movement of the field of view based on the detection result by the sensor 140. The processing device 150 changes the display by the projection device 121 and the projection device 122 in response to the movement of the field of view.

In addition, the processing device 150 can perform various processes using data obtained from the image camera 131 and the depth camera 132, the data of the storage device 170, etc. For example, the processing device 150 recognizes a prescribed object from the image acquired by the image camera 131. The processing device 150 recognizes the surface shape of the object from the image acquired by the depth camera 132. The processing device 150 calculates the viewpoint and line of sight of the worker's eyes from the detection result acquired by the eye-tracking camera 134.

The battery 160 supplies the power necessary for operation to each element of the MR device 100. The storage device 170 stores data necessary for the processing of the processing device 150, data obtained by the processing of the processing device 150, etc. The storage device 170 may be provided outside the MR device 100 and communicate with the processing device 150.

Not limited to the illustrated example, the MR device according to the embodiment may be a monocular-type head-mounted display. The MR device may be a glasses-type as illustrated, or may be a helmet type.

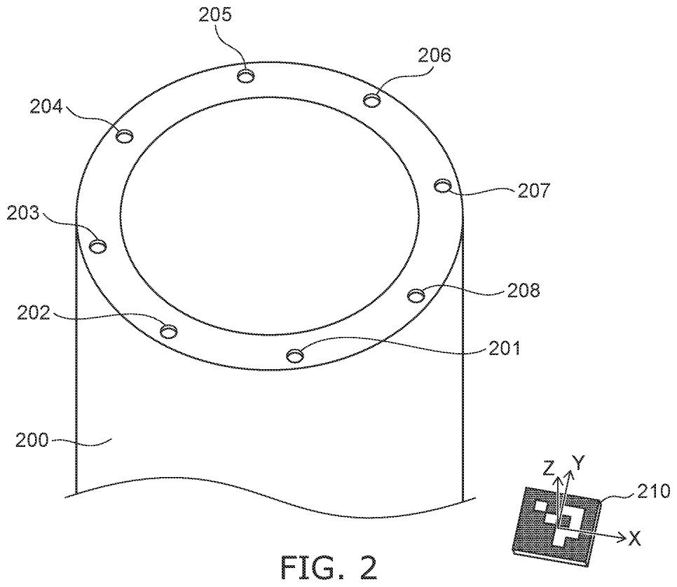

FIG. 2 is a schematic view illustrating a state of the real space.

Here, an example in which the first embodiment of the present invention is applied to a task of turning a screw will be described. As an example, the worker performs the task on the article 200 shown in FIG. 2 while wearing the MR device 100. The article 200 is a cylindrical member and includes fastening locations 201 to 208. The worker uses a wrench and an extension bar to turn the screws sequentially for each of the fastening locations 201 to 208.

First, a three-dimensional coordinate system in a virtual space is set based on a prescribed object. In the example shown in FIG. 2, a marker 210 is provided near the task object. The marker 210 is an AR marker. As will be described later, the marker 210 is provided for setting the origin of the three-dimensional coordinate system. Instead of the AR marker, a one-dimensional code (barcode), a two-dimensional code (QR code (registered trademark)), or similar may be used as the marker 210. Alternatively, instead of the marker, the origin may be indicated by the worker's hand (a hand gesture). The processing device 150 sets a three-dimensional coordinate system based on multiple points indicated by hand gestures. For example, the three-dimensional coordinate system is represented by the X-axis direction (first axis direction), the Y-axis direction (second axis direction), and the Z-axis direction perpendicular to each other.

As long as the three-dimensional coordinate system can be set, the object used for setting is freely-selected. Here, an example in which the three-dimensional coordinate system is set using the marker 210 will be described. At the start of the task, the image camera 131 and the depth camera 132 image the marker 210. The processing device 150 recognizes the marker 210 from the captured image. The processing device 150 sets the three-dimensional coordinate system in the virtual space based on the position and orientation of the marker 210. By setting the three-dimensional coordinate system based on the prescribed object existing in the real space, it is possible to display a virtual object corresponding to a physical object in the real space. The position at which the virtual object is displayed is pre-registered using the coordinate system based on the origin of the marker 210. The three-dimensional coordinate system used for registering the display position of a virtual object 301 and the three-dimensional coordinate system set when the MR device 100 is used are common.

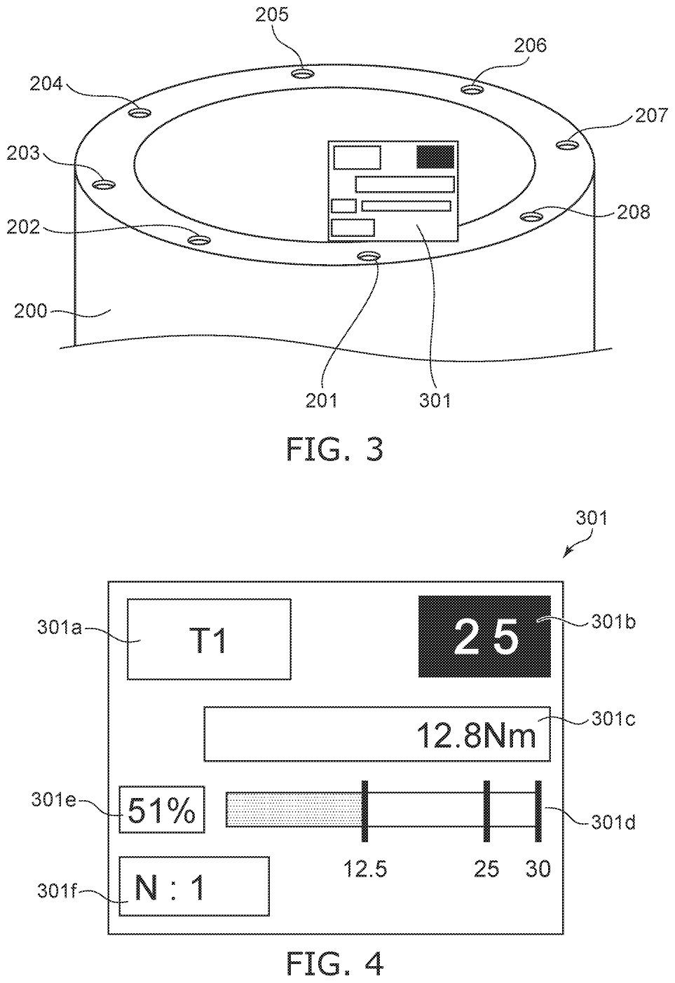

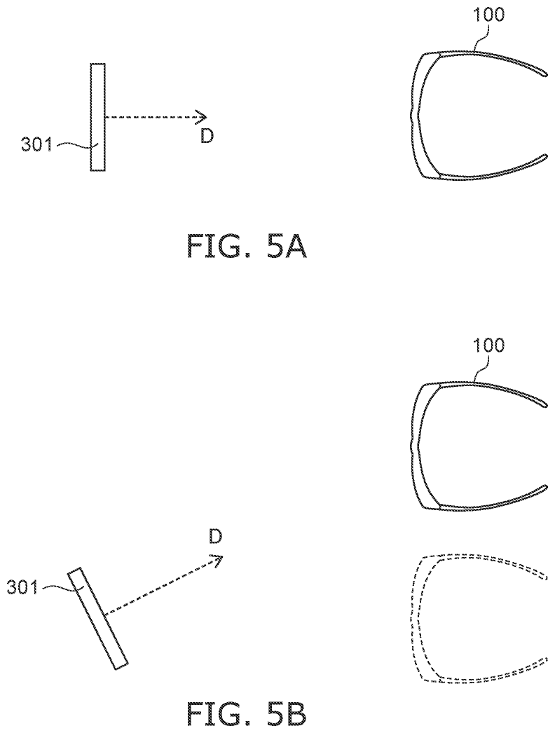

FIG. 3, FIG. 4, FIG. 5A, and FIG. 5B are schematic views illustrating display examples by the mixed reality device according to the first embodiment.

When the three-dimensional coordinate system is set, the processing device 150 displays a virtual object facing a predetermined direction at a predetermined position in the coordinate system. In the example shown in FIG. 3, the virtual object 301 is displayed at the position of the fastening location 201. For example, the virtual object 301 contains information related to the task. The worker can understand the information necessary for the task from the virtual object 301. In addition, the worker can understand that the task should be performed on the fastening location 201 near the virtual object 301.

As shown in FIG. 4, the virtual object 301 includes an identification number 301a, a specified torque value 301b, a detection value 301c, a meter 301d, a percentage 301e, and a number of times 301f. The identification number 301a is a unique identification number assigned to the fastening location 201. The specified torque value 301b is a torque value defined for tightening the screw at the fastening location 201.

In the task, a digital tool capable of detecting torque values may be used. The digital tool may be a digital torque wrench, a digital torque screwdriver, etc. In such a case, the detection value 301c indicates the torque value detected by the tool. The meter 301d indicates the specified torque value and the detected torque value. The percentage 301e indicates the ratio of the detected value to the specified torque value. Depending on the task, it is required to tighten the screw multiple times to one fastening location. In such a case, the number of times 301f indicates how many times the screw has been tightened at the fastening location 201. The worker performs the task while checking the contents displayed on the virtual object 301.

The processing device 150 further calculates the position of the MR device 100. As an example, the processing device 150 calculates the position and direction of the MR device 100 using spatial mapping function. In the MR device 100, the distance to the surrounding objects of the MR device 100 is measured by the depth camera 132. From the measurement results by the depth camera 132, surface information of the surrounding objects can be obtained. The surface information includes the position and orientation of the object's surface. For example, the surface of each object is represented by multiple meshes, and the position and direction are calculated for each mesh. The processing device 150 calculates the position and direction of the MR device 100 relative to the surrounding surfaces from the surface information. When the marker 210 is recognized, the position of each surface is also represented by the three-dimensional coordinate system based on the marker 210. From the positional relationship between the surfaces of the objects and the MR device 100, the position and direction of the MR device 100 in the three-dimensional coordinate system are calculated.

The spatial mapping is performed repeatedly at predetermined intervals. With each execution of spatial mapping, the surface information of the surrounding objects is obtained. The processing device 150 calculates changes in the surface position and direction between the present spatial mapping result and the last spatial mapping result. In a situation where the surrounding objects do not move, the change in the position of the surface and the change in the direction of the surface correspond to a change in the position of the MR device 100 and a change in the direction of the MR device 100, respectively. The processing device 150 calculates the change amounts in the position and direction of the MR device 100 from the change in the position of the surface and the change in the direction of the surface. The detection result of the sensor 140 may be further used to calculate the change amounts in the position and direction of the MR device 100. The processing device 150 updates the position and direction of the MR device 100 from the acquired change amounts. Instead of spatial mapping, a conventional positioning method may be used to acquire the position of the MR device 100.

The processing device 150 changes the display direction of the virtual object 301 according to the positional relationship between the MR device 100 and the virtual object 301. For example, as shown in FIG. 5A, the processing device 150 displays the virtual object 301 so that the display direction D of the virtual object 301 faces the MR device 100. The display direction D is a direction perpendicular to the display surface of the information of the virtual object 301. When the display direction D is facing the MR device 100, the information of the virtual object 301 is easiest for the worker to see.

When the worker moves, the processing device 150 calculates the position of the MR device 100 after the move. As shown in FIG. 5B, the processing device 150 changes the display direction D of the virtual object 301 according to the positional relationship between the MR device 100 and the virtual object 301. The display position of the virtual object 301 is fixed with respect to the fastening location 201. The processing device 150 changes the display direction D of the virtual object 301 by rotating the virtual object 301.

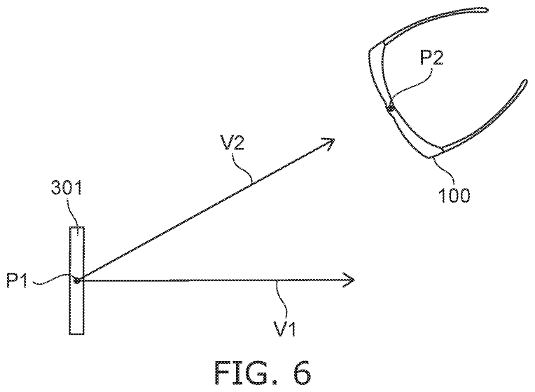

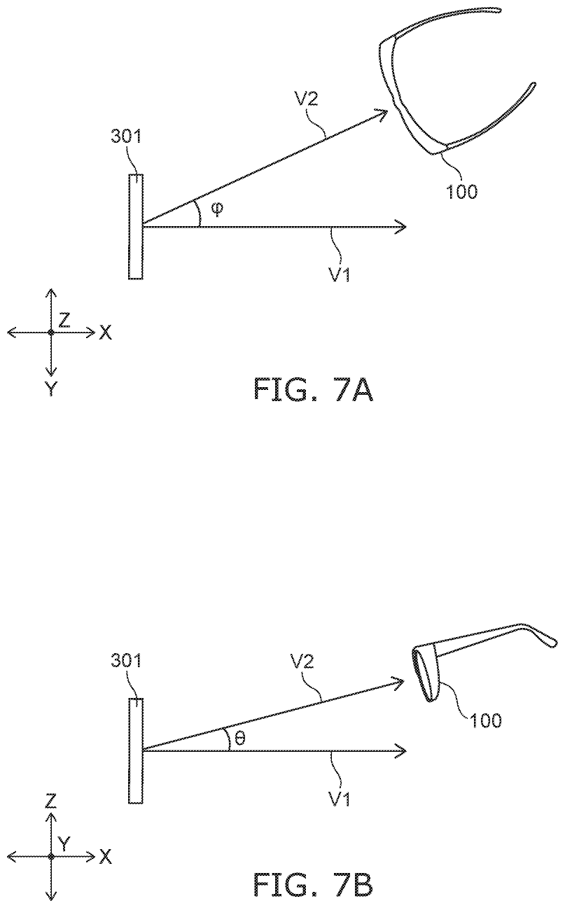

FIG. 6, FIG. 7A, and FIG. 7B are schematic views for explaining the processing by the mixed reality device according to the first embodiment.

As shown in FIG. 6, the processing device 150 calculates the first vector V1 which is along the display direction of the virtual object 301. In the illustrated example, the virtual object 301 has a flat display surface, and information is displayed on the display surface. The first vector V1 is perpendicular to the display surface. The processing device 150 calculates a second vector V2 from the position P1 of the virtual object 301 to the position P2 of the MR device 100. The processing device 150 calculates the angle between the first vector V1 and the second vector V2. The processing device 150 rotates the virtual object 301 by the calculated angle.

The specific calculation method of the angle is freely-selected. For example, as shown in FIG. 7A, the processing device 150 calculates the angle φ (a first angle) between the first vector V1 and the second vector V2 on the X-Y plane (a first plane). In addition, as shown in FIG. 7B, the processing device 150 calculates the angle θ (a second angle) between the first vector V1 and the second vector V2 on a plane (a second plane) that is perpendicular to the X-Y plane and parallel to the first vector V1. The processing device 150 rotates the display direction of the virtual object 301 by the angle θ and the angle φ. Thereby, the display of the virtual object 301 is controlled so that the virtual object 301 faces the worker.

The position calculated by the spatial mapping described above can be used as the position of the MR device 100. The worker's viewpoint may also be used as the position of the MR device 100. For example, after the position of the MR device 100 is calculated, the processing device 150 calculates the position of the worker's viewpoint using the detection result by the eye-tracking camera 134. The processing device 150 calculates the second vector V2 from the virtual object 301 to the viewpoint, and calculates the angle θ and the angle φ using the second vector V2. Thereby, the virtual object 301 can be oriented in the direction that is easier for the worker to see.

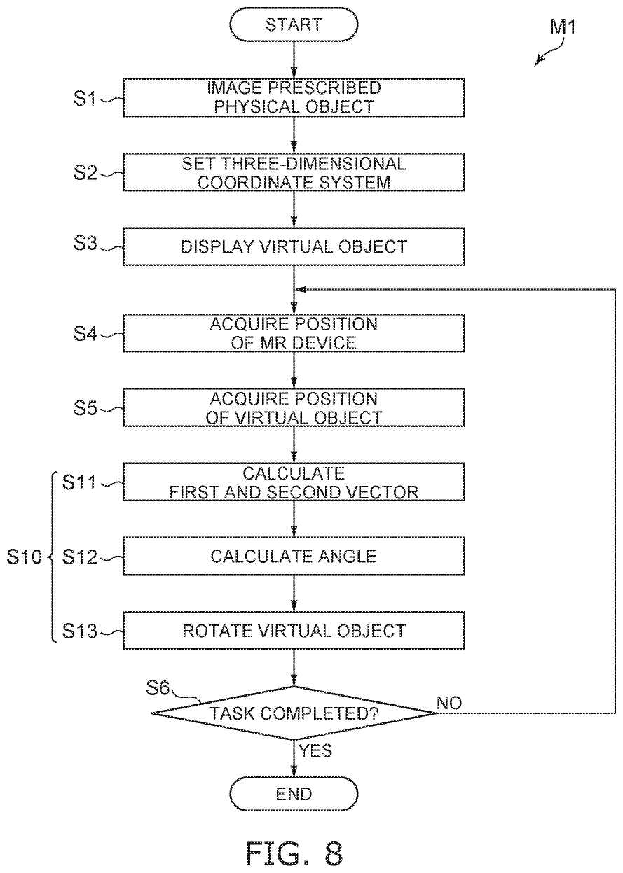

FIG. 8 is a flowchart illustrating a display control method by the mixed reality device according to the first embodiment.

In the display control method M1 shown in FIG. 8, first, the image camera 131 and the depth camera 132 images a prescribed physical object used as an origin (step S1). The processing device 150 recognizes the imaged origin and sets a three-dimensional coordinate system based on the position and orientation of the physical object (step S2). The processing device 150 displays a virtual object facing a predetermined direction at a predetermined position in the set three-dimensional coordinate system (step S3). The processing device 150 acquires the position of the MR device 100 (step S4). The position of the MR device 100 is calculated by spatial mapping. The position of the wearer's viewpoint may be acquired as the position of the MR device 100. The processing device 150 acquires the position of the displayed virtual object (step S5).

The processing device 150 controls the display direction of the virtual object (step S10). Specifically, the processing device 150 calculates the first vector that is along the display direction of the virtual object 301 and the second vector from the virtual object 301 toward the MR device 100 (step S11). The processing device 150 calculates the angle between the first vector and the second vector (step S12). The processing device 150 rotates the virtual object 301 by the calculated angles (step S13).

The processing device 150 determines whether the task has been completed (step S6). When the task is not completed, the processing device 150 executes the step S4 again. As a result, the control of the display direction is continuously repeated until the task is completed.

The advantages of the first embodiment will be described.

The MR device 100 can provide a variety of information to the wearer by displaying a virtual object. When the wearer performs a task, information related to the task can be provided by the virtual object. In addition, the MR device 100 sets the coordinate system in the virtual space based on a physical object imaged in the real space. Therefore, the MR device 100 can display the virtual object corresponding to a specific object in the real space. On the other hand, when the virtual object is displayed at a predetermined position in the real space, the virtual object may become difficult for the wearer to see depending on its direction.

For example, as shown in FIG. 4, the virtual object 301 including various information is displayed. The worker can obtain information related to the task from the virtual object 301. When the display direction of the virtual object 301 is fixed, the worker cannot read the information of the virtual object 301 from an angle or the side of the virtual object 301. The worker needs to move in front of the virtual object 301 and check the information of the virtual object 301.

In the first embodiment of the present invention, the processing device 150 changes the display direction of the virtual object 301 according to the positional relationship between the MR device 100 and the virtual object 301. Therefore, as shown in FIGS. 5A and 5B, when the worker moves, the display direction of the virtual object 301 changes according to the movement. The display direction of the virtual object 301 is controlled so that the worker can easily see the virtual object 301. According to the first embodiment, the usability of the MR device 100 can be improved.

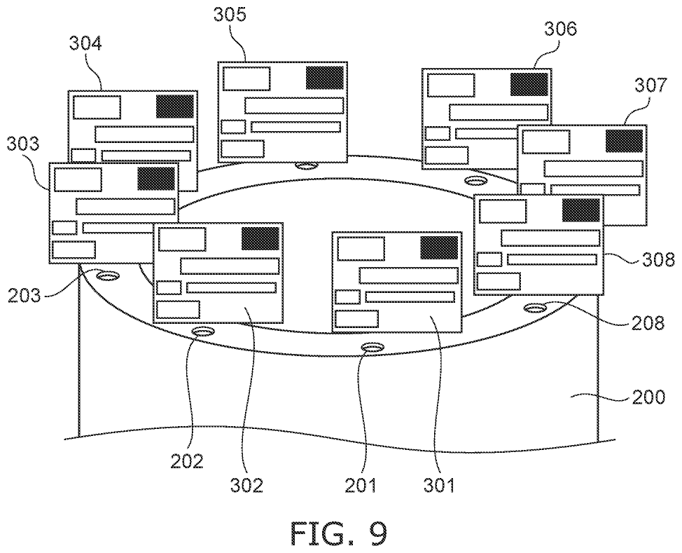

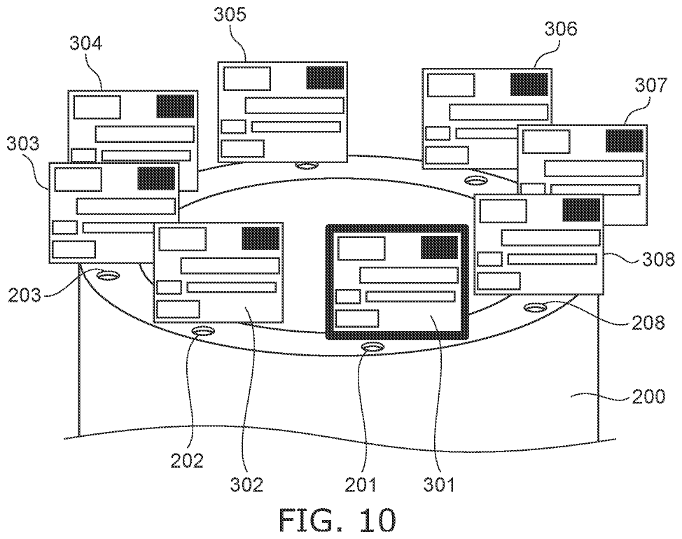

FIGS. 9 and 10 are schematic views illustrating display examples by the mixed reality device according to the first embodiment.

The MR device 100 may simultaneously display multiple virtual objects. For example, as shown in FIG. 9, the MR device 100 displays virtual objects 301 to 308 for the fastening locations 201 to 208 of the article 200, respectively. Similar to the virtual object 301, the virtual objects 302 to 308 respectively include information related to tasks on the fastening locations 202 to 208. In such a case, the processing device 150 calculates the positional relationship between each of the virtual objects 301 to 308 and the MR device 100. The processing device 150 changes the display direction of each of the virtual objects 301 to 308 according to the calculated positional relationship.

The processing device 150 may determine a virtual object that overlaps the line of sight among the multiple virtual objects. For example, when the line of sight is calculated while multiple virtual objects are displayed, the processing device 150 determines the virtual object overlapping the line of sight. As shown in FIG. 10, the processing device 150 may differentiate the display mode of the virtual object overlapping with the line of sight from the display modes of the other virtual objects. In the example shown in FIG. 10, the frame of the virtual object 301 is displayed thicker than those of the virtual objects 302 to 308, and the virtual object 301 is emphasized more than the virtual objects 302 to 308. The virtual object 301 may also be emphasized by changing the color, shape, or size of the virtual object 301.

### Second Embodiment

A second embodiment of the present invention will be described. In the second embodiment, the same MR device 100 as in the first embodiment may be used. Here, an example of the second embodiment of the present invention being applied to the task of turning a screw will be described.

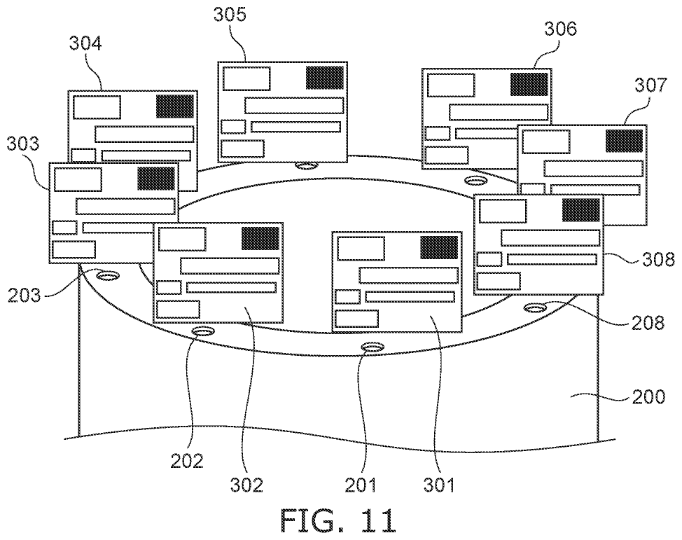

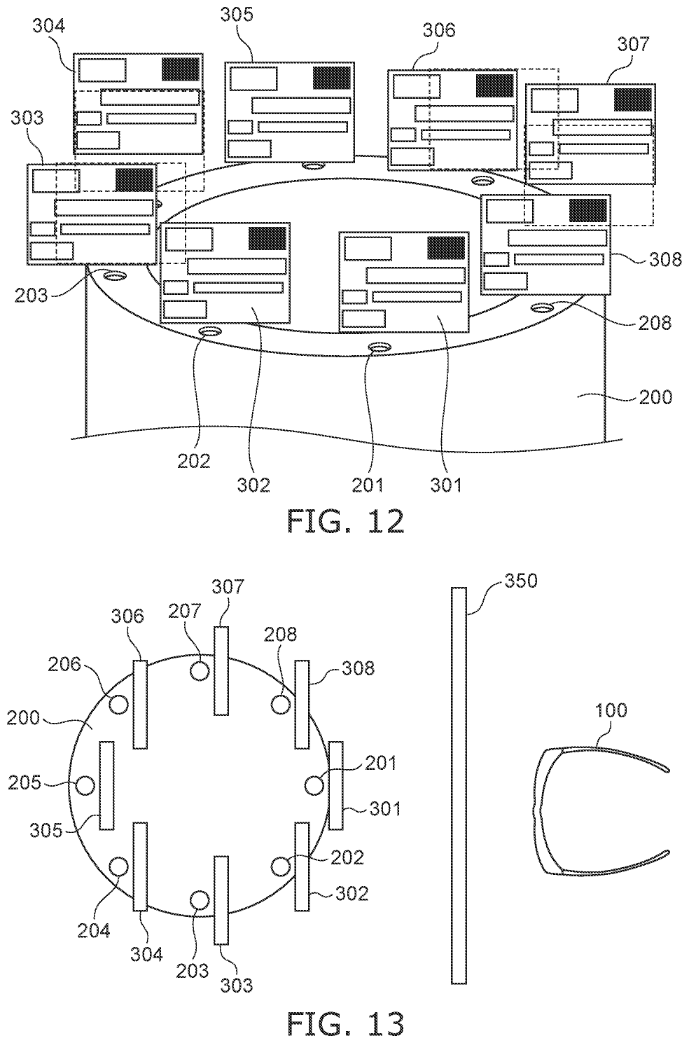

FIGS. 11 and 12 are schematic views illustrating display examples by a mixed reality device according to the second embodiment.

In the second embodiment, the MR device 100 displays multiple virtual objects. For example, as shown in FIG. 11, the MR device 100 displays virtual objects 301 to 308 for the fastening locations 201 to 208, respectively. The processing device 150 determines whether or not two or more of the virtual objects 301 to 308 overlap with each other. When the virtual objects overlap, the processing device 150 changes the display positions of the virtual objects to reduce the overlapping amount.

In the example shown in FIG. 11, the processing device 150 determines that the virtual object 302 and the virtual object 303 overlap with each other, and determines that the virtual object 303 and the virtual object 304 overlap with each other. In addition, the processing device 150 determines that the virtual object 306 and the virtual object 307 overlap with each other, and determines that the virtual object 307 and the virtual object 308 overlap with each other.

The processing device 150 changes the display position of at least one of the virtual object 302 and the virtual object 303, and changes the display position of at least one of the virtual object 303 and the virtual object 304. In addition, the processing device 150 changes the display position of at least one of the virtual object 306 and the virtual object 307, and changes the display position of at least one of the virtual object 307 and the virtual object 308. As a result, the overlapping amount between the virtual objects 302 and 303, the overlapping amount between the virtual objects 303 and 304, the overlapping amount between the virtual objects 306 and 307, and the overlapping amount between the virtual objects 307 and 308 are reduced. For example, as shown in FIG. 12, any of the virtual objects 301 to 308 are displayed so that they do not overlap with each other. In FIG. 12, the display positions of the virtual objects before being moved are shown by dashed lines.

FIGS. 13 to 15, FIGS. 16A to 16C, FIG. 17, FIG. 18A, and FIG. 18B are schematic views for explaining processing by the mixed reality device according to the second embodiment.

A determination method of the overlap between virtual objects will be described now. As shown in FIG. 13, the processing device 150 sets a virtual surface 350 between the MR device 100 and the virtual object. As shown in FIG. 14, multiple regions 351 are set in the virtual surface 350. The multiple regions 351 are arranged along a first direction D1 and a second direction D2. The first direction D1 is parallel to the horizontal plane and perpendicular to the direction connecting any one of virtual objects and the MR device 100. The second direction D2 is parallel to the vertical direction.

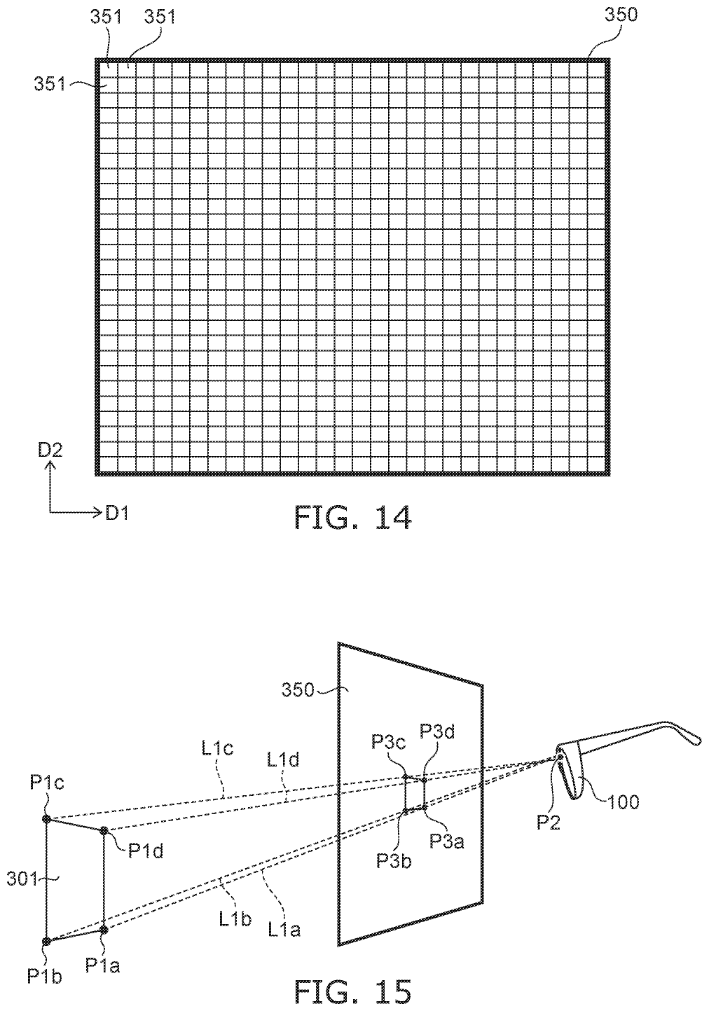

The processing device 150 projects each virtual object onto the virtual surface 350. For example, as shown in FIG. 15, the processing device 150 acquires the positions P1a to P1d of multiple points on the outer edge of the virtual object 301. The number of positions to be acquired can be appropriately changed according to the shape, size, etc. of the virtual object. The processing device 150 calculates the line segments L1a to L1d respectively connecting the positions P1a to P1d and the position P2 of the MR device 100. The processing device 150 calculates the positions P3a to P3d at the intersections of the line segments L1a to L1d and the virtual surface 350. The area surrounded by the positions P3a to P3d is the virtual object 301 projected onto the virtual surface 350. The processing device 150 projects the other virtual objects onto the virtual surface 350 in a similar manner.

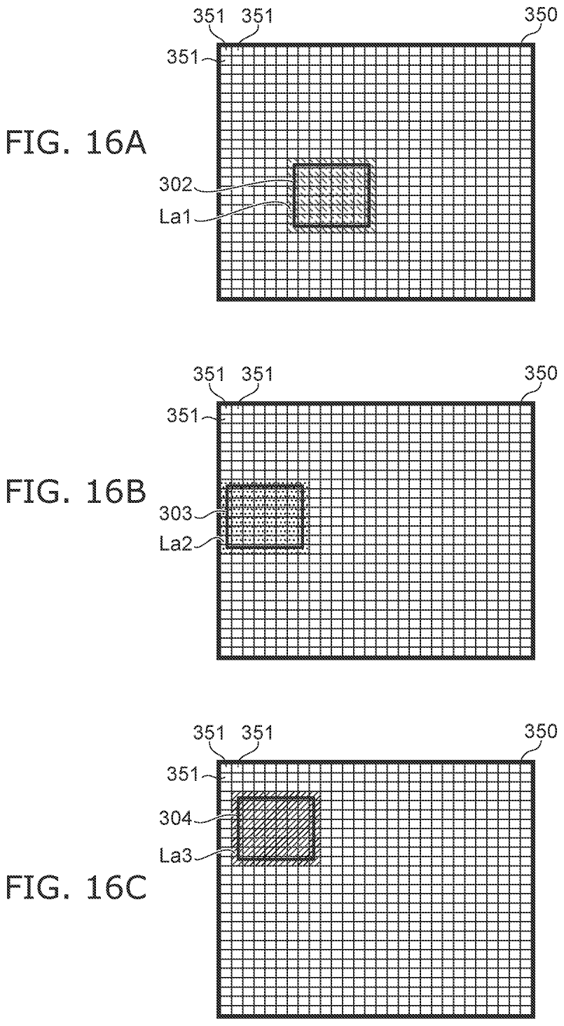

For example, as shown in FIG. 16A, the virtual object 302 is projected onto the virtual surface 350. The processing device 150 identifies regions 351 that overlaps with the virtual object 302 among the multiple regions 351. The processing device 150 assigns the label La1 to the regions 351 that overlap with the virtual object 302.

When the virtual object 303 is projected onto the virtual surface 350, as shown in FIG. 16B, the processing device 150 identifies regions 351 that overlap with the virtual object 303 among the multiple regions 351, and assigns the label La2 to these regions 351. When the virtual object 304 is projected onto the virtual surface 350, as shown in FIG. 16C, the processing device 150 identifies regions 351 that overlap with the virtual object 304 among the multiple regions 351, and assigns the label La3 to these regions 351. Similarly, other virtual objects are also projected onto the virtual surface 350, and labels are assigned to regions 351 that overlap with any of the virtual objects.

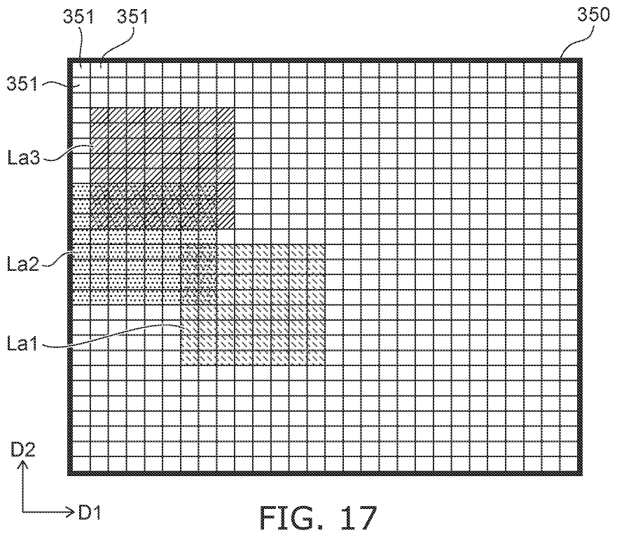

The processing device 150 determines whether multiple labels are assigned to one region 351. The assignment of multiple labels to one region 351 indicates that multiple virtual objects overlap in the region 351. As a result of the process shown in FIGS. 16A to FIG. 16C, the labels La1 and La2 are assigned to one or more regions 351, and the labels La2 and La3 are assigned to another one or more regions 351, as shown in FIG. 17. In such a case, the processing device 150 determines that the virtual object 302 and the virtual object 303 overlap, and the virtual object 303 and the virtual object 304 overlap. Hereinafter, the region 351 to which two or more labels are assigned in duplicate is referred to as an “overlapping region”.

The processing device 150 searches for the position of the virtual object where the overlapping amount decreases. In the example shown in FIG. 17, the overlapping amount can be represented by the number of overlapping regions. In other words, the processing device 150 searches for the position of the virtual object that reduces the number of overlapping regions. Preferably, the processing device 150 searches for the position of the virtual object so that the number of overlapping regions is zero. When there is no overlapping region, the worker can see all the virtual objects without overlapping. Thereby, each virtual object is in the most visible state for the worker.

In the search for the position of the virtual object, the position of at least one virtual object is changed. During the search, the display position of the virtual object does not change. The display position of the virtual object is moved to the final adopted position after the search is completed. The processing device 150 determines whether the overlapping region exists after changing the position. When the number of overlapping regions is reduced after the position change, the processing device 150 adopts the position after the change. The processing device 150 changes the display position of the virtual object to the adopted position. This reduces the amount of overlap between the virtual objects.

A preferred specific example of the method for searching the position of the virtual object will be described. First, the processing device 150 determines the priority of each virtual object overlapping with each other. The method of determining priority is freely-selected. The priority of each virtual object is determined based on the importance of each virtual object, the importance of the task location corresponding to each virtual object, or the positional relationship between each virtual object and the MR device 100, etc. For example, the closer the virtual object is to the MR device 100, the higher the priority of the virtual object is set.

The processing device 150 changes the position of the virtual object with the lowest priority on the virtual surface 350. Specifically, the processing device 150 changes the position of the virtual object by a predetermined distance in a predetermined direction according to a preset rule.

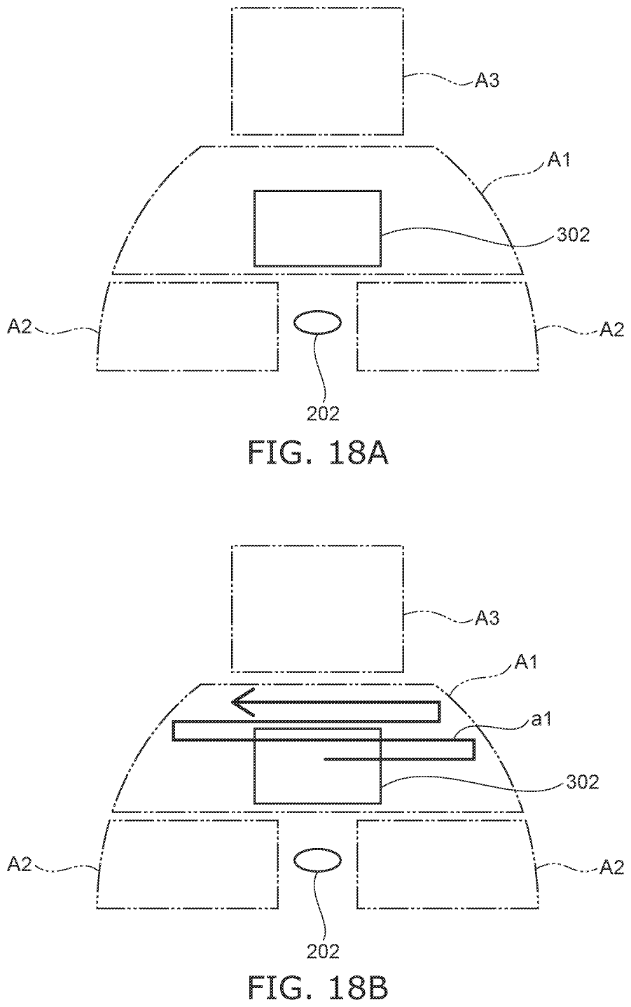

For example, as shown in FIG. 18A, the processing device 150 sets areas A1 to A3 with reference to the projected virtual object 302. The number of areas to be set, the size of each area, the positional relationship between areas, etc. are registered in advance. The area A1 includes the display position of the virtual object 302. A pair of areas A2 are set on both sides of the fastening location 202. The area A3 is set opposite to the pair of areas A2 with respect to the area A1. The area A1 is located between the pair of areas A2 and the area A3. The processing device 150 sequentially searches for the display position of the virtual object in the area A1, the pair of areas A2, and the area A3.

As shown in FIG. 18B, the processing device 150 searches for a position where the virtual objects do not overlap while changing the position of the virtual object in the area A1, as indicated by the arrow a1. When a position where the virtual objects do not overlap is found in the area A1, the processing device 150 adopts that position as the changed position for the virtual object.

When a position where the virtual objects do not overlap cannot be found in the area A1, the processing device 150 searches for a position in the pair of areas A2. The search may start from any of the pair of areas A2. When a position where the virtual objects do not overlap is found in the area A2, the processing device 150 adopts that position as the changed position for the virtual object. When a position where the virtual objects do not overlap cannot be found in either of the areas A2, the processing device 150 searches for a position in the area A3. When a position where the virtual objects do not overlap is found in the area A3, the processing device 150 adopts that position as the changed position for the virtual object.

When it is not possible to find a position where the virtual objects do not overlap in any of the areas A1 to A3, the processing device 150 adopts the position with the least overlapping amount as the changed position for the virtual object. The processing device 150 reflects the adopted position on the virtual surface 350 to the display position of the virtual object. Thereby, the display position of the virtual objects is controlled so as to reduce the overlapping amount between the virtual objects. For example, by performing the reverse process of the one shown in FIG. 15, the adopted position is reflected to the display position of the virtual object. Specifically, the processing device 150 generates four straight lines connecting the four corners of the adopted position and the MR device 100, respectively. The intersection points of the surface including the positions P1a to P1d of the original virtual object 302 and the four straight lines are the positions of the four corners after the change of the virtual object 302.

Not limited to the above-described examples, the shape of the virtual surface 350, the shape and arrangement of the regions 351, the projection method on the virtual surface 350, the method of searching for the position of the virtual object, etc. can be appropriately changed. For example, the virtual surface 350 is not planar but may be curved. A part of the cylindrical surface centered on the position of the MR device 100 or a part of the spherical surface centered on the position of the MR device 100 may also be used as the virtual surface 350. The region 351 may be triangular or hexagonal and may be arranged in two directions that are not orthogonal to each other.

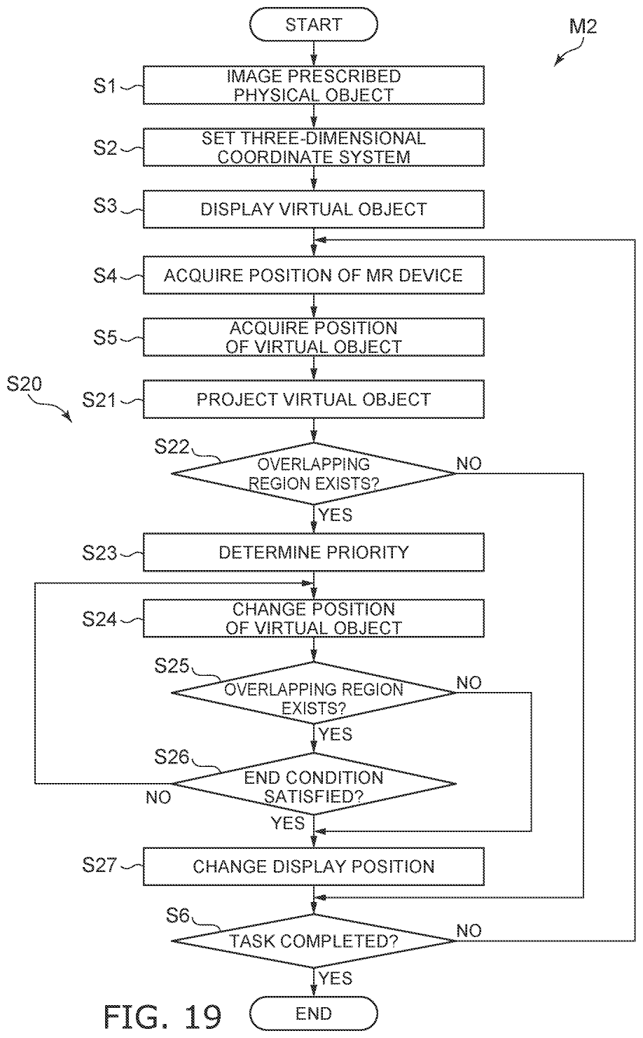

FIG. 19 is a flowchart illustrating a display control method by the mixed reality device according to the second embodiment.

In the display control method M2 shown in FIG. 19, first, the steps S1 to S5 are executed in the same manner as the display control method M1 shown in FIG. 8. After that, the processing device 150 executes control of the display position of the virtual object (step S20). Specifically, the processing device 150 sets a virtual surface and projects the displayed virtual object onto the virtual surface (step S21). The processing device 150 assigns a label to the area overlapping the virtual object on the virtual surface. The processing device 150 determines whether there is an overlapping region to which two or more labels are assigned (step S22). When there is no overlapping region, the display position of the virtual object remains unchanged.

When there is an overlapping region, the position of the virtual object is searched. In the position search, steps S23 to S25 are executed. In the step S23, the processing device 150 determines the priority of each of the virtual objects that overlap each other. In the step S24, the processing device 150 selects one of the virtual objects according to the priority and changes the position of the virtual object. In the step S25, the processing device 150 determines whether an overlapping region exists at the changed position on the virtual surface.

When it is determined that there is an overlapping region in the step S25, the processing device 150 determines whether an end condition for the search is satisfied (step S26). Searching the entire set area, performing a preset number of position changes, or the elapse of a preset time from the start of the search are set as the end conditions. When the end condition is not satisfied, the processing device 150 executes the step S24 again and continues to search for the position.

When it is determined in the step S25 that there is no overlapping region, the display position of the virtual object is changed to that position obtained in the previous step S24 (step S27). When it is determined that the end condition is satisfied in the step S26, the processing device 150 extracts the position with the least overlapping amount among the positions searched so far. The processing device 150 changes the display position of the virtual object to the position with the least overlapping amount (step S27).

When it is determined that there is no overlapping region in the step S22, or after the step S27, the processing device 150 determines whether the task is completed (step S6). When the task is not completed, the processing device 150 executes the step S4 again. This ensures that the control of the display position is continuously repeated until the task is completed.

The advantages of the second embodiment will be described.

There may be cases where multiple virtual objects are simultaneously displayed by the MR device 100. In such cases, if the virtual objects overlap each other, it may be difficult for the wearer to see the virtual objects. As shown in FIG. 4, when information is displayed on the virtual object, it may be difficult for the wearer to understand the information.

According to the second embodiment of the present invention, when two or more virtual objects overlap, the processing device 150 changes the display position of at least one of the two or more virtual objects to reduce the overlapping amount. By reducing the overlapping amount between the virtual objects, each virtual object becomes easier for the wearer to see. For example, when information is displayed on these virtual objects, it becomes easier for the wearer to understand the information. According to the second embodiment, the usability of the MR device 100 can be improved.

The first embodiment and the second embodiment may be combined. In such a case, after displaying the virtual object, the processing device 150 changes the directions of the virtual objects according to the positional relationship between the MR device 100 and the virtual objects, and changes the display position of the virtual object to reduce the overlap between the virtual objects.

### EXAMPLE

Here, a case in which both the first embodiment and the second embodiment are applied to the task of screw-tightening will be described.

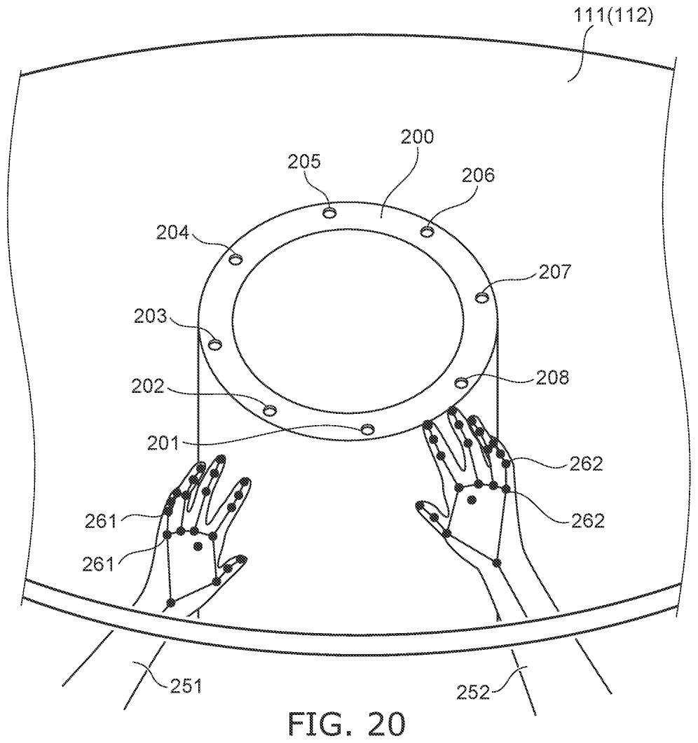

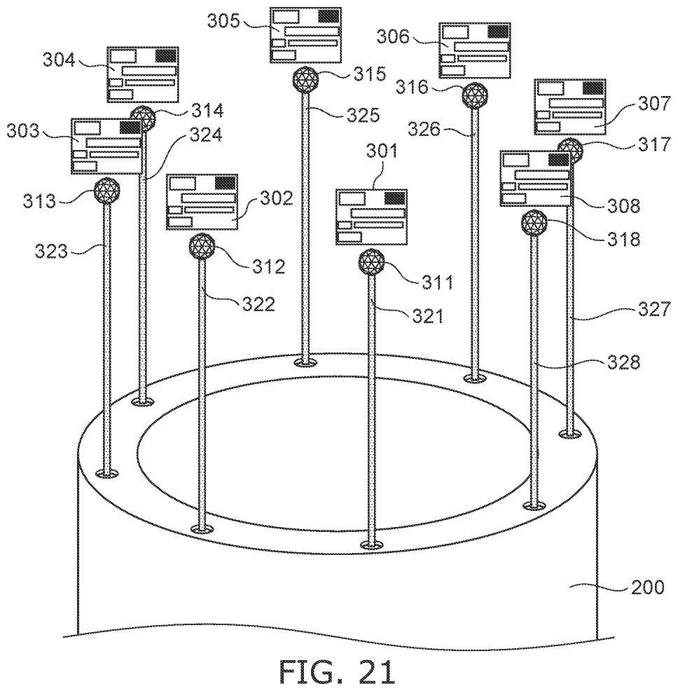

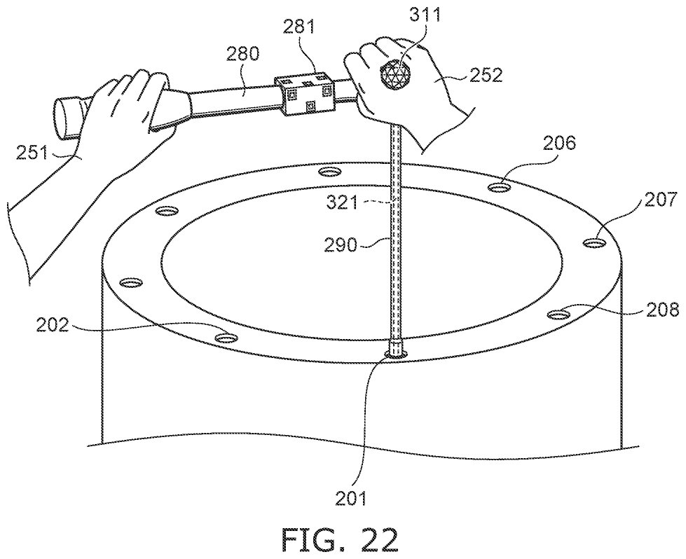

FIGS. 20 and 21 are schematic views illustrating display examples by the mixed reality device according to the embodiment. FIG. 22 is a schematic view illustrating a state of the task.

A worker wearing the MR device 100 performs a screw-tightening task. During the task, the article 200, the worker's left hand 251, and the worker's right hand 252 are imaged by the image camera 131 and the depth camera 132. The processing device 150 recognizes the left hand 251 and the right hand 252 from the captured image using hand tracking.

For example, as shown in FIG. 20, the processing device 150 displays the recognition result of the left hand 251 and the recognition result of the right hand 252 superimposed on the hands in the real space. In the illustrated example, multiple virtual objects 261 and multiple virtual objects 262 are displayed as the recognition results of the left hand 251 and the right hand 252. The multiple virtual objects 261 represent multiple joints of the left hand 251, respectively. The multiple virtual objects 262 represent multiple joints of the right hand 252, respectively. Instead of joints, virtual objects (meshes) indicating the surface shape of the left hand 251 and the surface shape of the right hand 252 may be displayed, respectively.

When the left hand 251 and the right hand 252 are recognized, the processing device 150 measures the position of each hand. Specifically, the hand includes multiple joints, such as DIP joints, PIP joints, MP joints, CM joints, etc. The position of any of these joints is used as the position of the hand. The position of the center of gravity of the multiple joints may also be used as the position of the hand. Alternatively, the overall center position of the hand may be used as the position of the hand.

As shown in FIG. 21, the processing device 150 displays virtual objects 301 to 308, virtual objects 311 to 318, and virtual objects 321 to 328. The virtual objects 311 to 318 are displayed corresponding to the fastening locations 201 to 208, respectively, and are displayed apart from the fastening locations 201 to 208. The virtual objects 321 to 328 are displayed between the fastening locations 201 to 208 and the virtual objects 311 to 318, respectively. In the illustrated example, the virtual objects 311 to 318 are spherical, and the virtual objects 321 to 328 are rod-shaped. The virtual objects 301 to 308 are displayed near the virtual objects 311 to 318, respectively.

The virtual objects 311 to 318 indicate the positions where the hand should be located when the screws are tightened into the fastening locations 201 to 208, respectively. The virtual objects 321 to 328 indicate the positions where the extension bar should be placed when the screws are tightened into the fastening locations 201 to 208, respectively. For example, when the screw is tightened into the fastening location 201, the hand comes into contact with the virtual object 311 as shown in FIG. 22. The extension bar 290 overlaps the virtual object 321. Note that the virtual objects 312 to 318 and the virtual objects 322 to 328 are omitted in FIG. 22. The worker rotates the wrench 280 while holding one end of the extension bar 290 and the head of the wrench 280 with one hand. Thereby, the screw is turned to the fastening location 201.

Displaying the virtual object 311 to 318 and the virtual object 321 to 328 allows the worker to easily understand where to position the hand and the extension bar during the screw-tightening. Thereby, task efficiency can be improved.

The processing device 150 may detect contact between a prescribed physical object and a virtual object. For example, the processing device 150 detects contact between the hand and the virtual objects 311 to 318. More specifically, the processing device 150 repeatedly calculates the distance between the hand and each of the virtual objects 311 to 318. When the distance to any virtual object falls below a preset threshold, the processing device 150 determines that the hand comes into contact with that virtual object.

When a hand comes into contact with any virtual object, the processing device 150 estimates (infers) that a screw is being turned to a location corresponding to the virtual object. For example, as shown in FIG. 22, when the screw is turned to the fastening location 201, one hand rotates the wrench 280 and the other hand holds the head of the wrench 280. At this time, the hand comes into contact with the virtual object 301. The processing device 150 detects the contact, and estimates that the screw is being turned to the fastening location 201 corresponding to the virtual object 301.

Alternatively, instead of a hand, contact between a tool and a virtual object may be detected. When a tool and an object come into contact, it can be estimated that the screw is being tightened into the fastening location corresponding to the object, as in the example described above. Various methods can be used to estimate the position of the tool. For example, a sensor may be provided on the wrench 280, and the position of the wrench 280 may be estimated using the detection value of the sensor. The sensor may be an inclination sensor, an acceleration sensor, a gyro sensor, etc. The position of the wrench 280 may be estimated by combining the detection value of the sensor and the hand detection result.

Alternatively, a marker for estimating the position of the tool may be attached to the tool. In the example shown in FIG. 22, multiple markers 281 are attached to the wrench 280. The processing device 150 recognizes one or more markers 281 in the image. The processing device 150 calculates the position of a specific portion (e.g. the head) of the tool based on the recognized markers 281 and their positional relationship.

Once the position of the tool is calculated, the processing device 150 calculates the distance between the position of the tool and the virtual object. When the distance to any virtual object falls below a preset threshold, the processing device 150 determines that the tool comes into contact with the virtual object.

When the hand or tool comes into contact with the virtual object, the processing device 150 can estimate the location where the screw is being turned. For example, by presuming the location where the screw is being turned, a task record showing which parts have been worked on can be automatically generated. Alternatively, when the order of tasks is specified for multiple locations, it can be automatically determined whether or not the location where the screw is tightened is appropriate.

When the wrench 280 is a digital tool, the processing device 150 receives the detection value from the wrench 280. In such a case, the processing device 150 may associate the detection value such as torque with the data related to the estimated location to be worked on. When the torque required for fastening the screw is pre-registered, the processing device 150 may determine whether the required torque has been detected. In addition to the torque value, the processing device 150 registers the determination result in the task record.

In addition, the processing device 150 performs control of the display direction and display position of the virtual object. For example, virtual objects for which the display direction is controlled and virtual objects for which the display position is controlled are registered in advance. The processing device 150 changes the display direction of the virtual object for which the display direction is controlled according to the positional relationship between the virtual object and the MR device 100. The processing device 150 changes the display position of the virtual object for which the display position is controlled according to whether or not the virtual objects overlap.

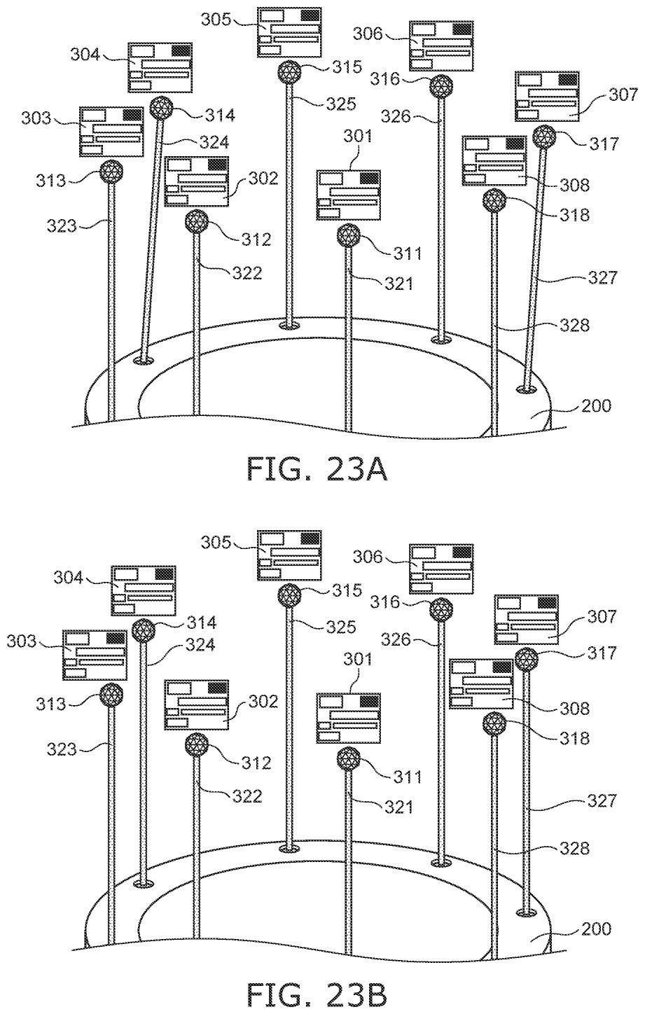

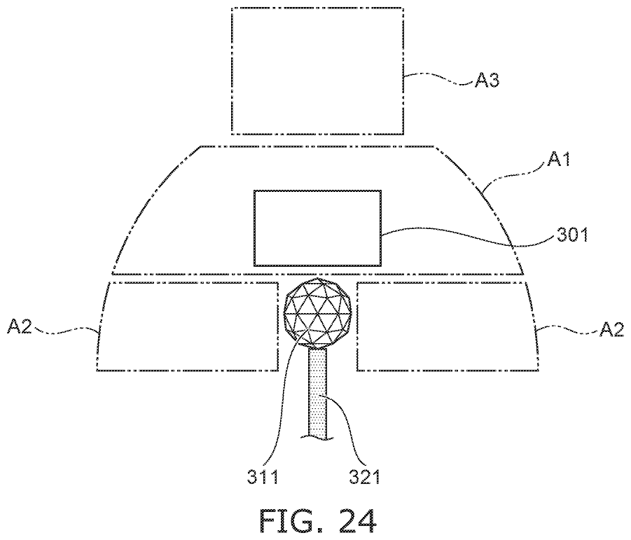

FIGS. 23A and 23B are schematic views illustrating display examples by the mixed reality device according to the embodiment.

For example, the display directions of the virtual objects 301 to 308 are controlled. Additionally, the display positions of the virtual objects 301 to 308, the virtual objects 311 to 318, and the virtual objects 321 to 328 are controlled. In the example shown in FIG. 21, the processing device 150 determines that the virtual object 303 overlaps the virtual object 314 and the virtual object 324, and the virtual object 308 overlaps the virtual object 317 and the virtual object 327.

The processing device 150 determines the priority of each of the virtual object 303, the virtual object 314, and the virtual object 324. In addition, the processing device 150 determines the priority of each of the virtual object 308, the virtual object 317, and the virtual object 327. The processing device 150 changes the display position of the virtual object with the lower priority to reduce the overlapping amount between the virtual objects. Note that the priority relationship for each type of virtual object may be registered in advance.

When the priority of the virtual object 303 is higher than the priority of each of the virtual object 314 and the virtual object 324, the display positions of the virtual object 314 and the virtual object 324 are changed as shown in FIG. 23A. As a result, the virtual object 314 and the virtual object 324 are displayed at positions where they do not overlap with the virtual object 303. Similarly, the display positions of the virtual object 317 and the virtual object 327 are changed, and the virtual object 317 and the virtual object 327 are displayed at positions where they do not overlap with the virtual object 308.

When the priority of the virtual object 303 is lower than the priorities of the virtual object 314 and the virtual object 324, the display position of the virtual object 303 is changed as shown in FIG. 23B. Similarly, the display position of the virtual object 308 is changed. As a result, the virtual object 303 is displayed at a position that does not overlap with the virtual object 314 and the virtual object 324. The virtual object 308 is displayed at a position that does not overlap with the virtual object 317 and the virtual object 327.

FIG. 24 is a schematic view for explaining processing by the mixed reality device according to the embodiment.

For example, each priority of the virtual objects 301 to 308 is set lower than the priorities of the virtual objects 311 to 318 and the virtual objects 321 to 328. In such a case, the display positions of the virtual objects 301 to 308 are preferentially changed. As an example, when the display position of the virtual object 301 is searched, the processing device 150 sets the areas A1 to A3 based on the display position of the virtual object 301 as shown in FIG. 24. The area A1 includes the display position of the virtual object 301. A pair of the areas A2 are set on both sides of the virtual object 311. The area A3 is set opposite to the pair of areas A2 with respect to the area A1. The area A1 is positioned between the pair of areas A2 and the area A3. The processing device 150 sequentially searches for the display position of the virtual object in the area A1, the pair of areas A2, and the area A3.

In addition, the display directions of the virtual objects 301 to 308 are appropriately changed according to the positional relationships between the MR device 100 and the virtual objects 301 to 308, respectively. Thereby, even when the worker moves, the virtual objects 301 to 308 are displayed in directions that are easy for the worker to see. Since the virtual objects 311 to 318 and the virtual objects 321 to 328 are rotationally symmetric with respect to an axis parallel to the Z-axis direction, the control of the display direction of the virtual objects may be omitted.

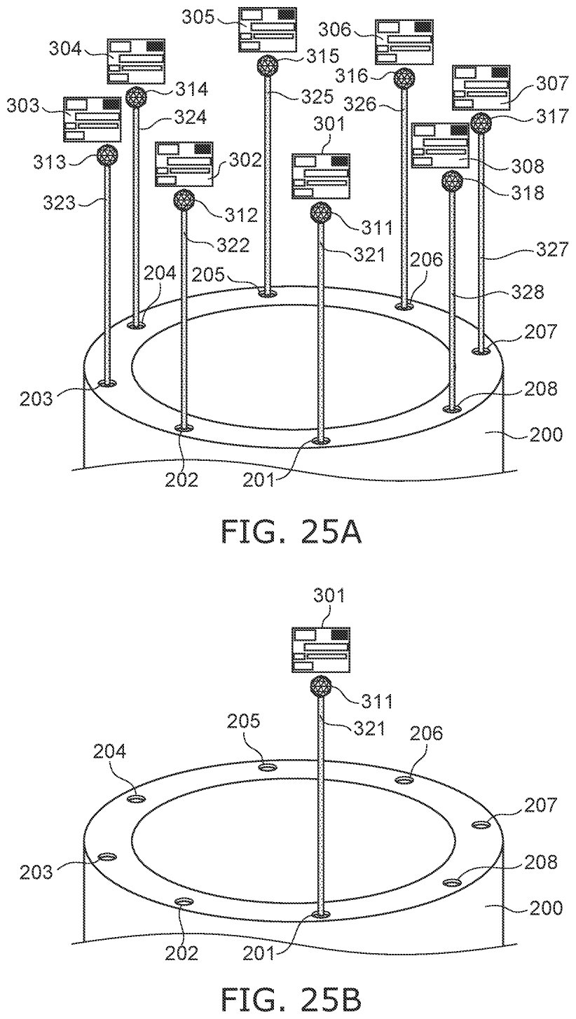

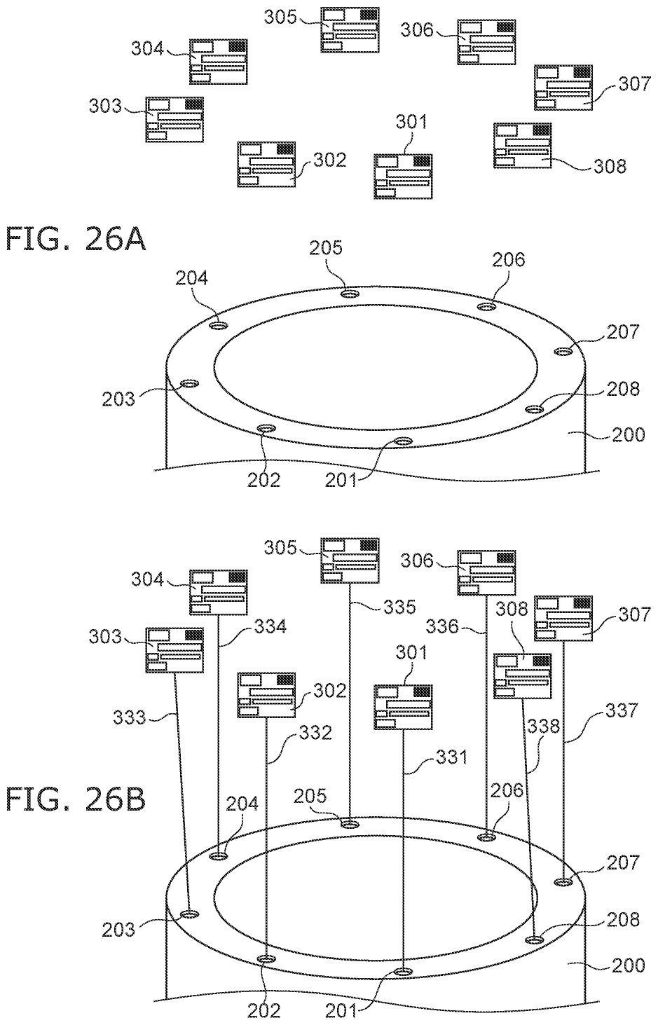

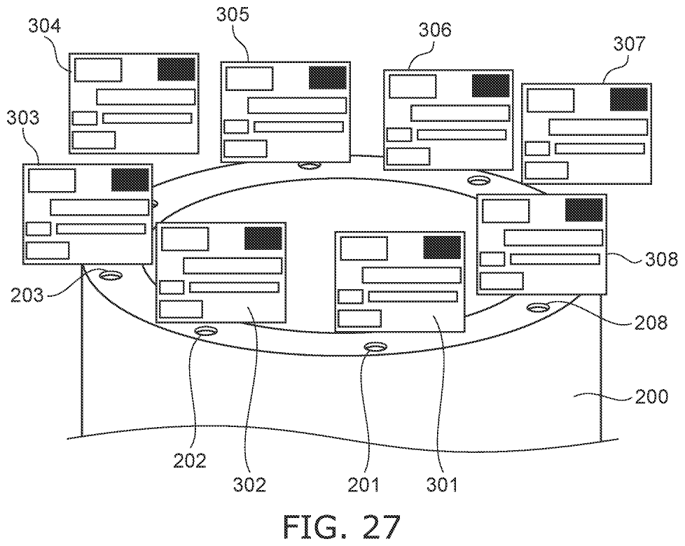

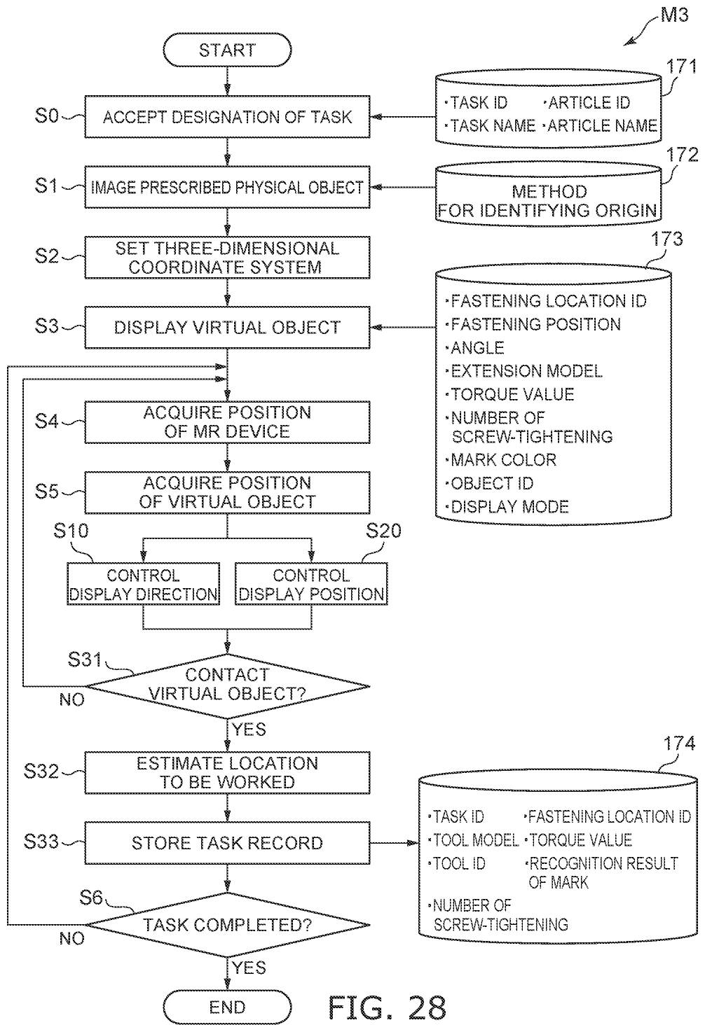

FIG. 25A, FIG. 25B, FIG. 26A, FIG. 26B, and FIG. 27 are schematic views illustrating display examples by the mixed reality device according to the embodiment.

The MR device 100 may switch between a first mode in which only a virtual object related to a specific fastening location is displayed and a second mode in which virtual objects related to multiple fastening locations are displayed.

For example, when the order in which the screws are turned to multiple fastening locations is predetermined, the processing device 150 displays only the virtual object related to the next fastening location where a screw should be turned. In the first mode, the worker can easily understand the fastening location where the screw should be turned next. In addition, it is easy for the worker to identify the virtual object to focus on. When the task is completed for all fastening locations, the processing device 150 simultaneously displays virtual objects related to the multiple fastening locations. In the second mode, the worker can check whether the task has been appropriately performed for all fastening locations while looking at multiple virtual objects.

The worker may switch between the first mode and the second mode. For example, the worker inputs a hand gesture or voice command to the MR device 100 to switch between the first mode and the second mode. The processing device 150 switches between the first mode and the second mode in response to the input of hand gestures or voice commands.

In the second mode, as shown in FIG. 26A, the display of the virtual objects 311 to 318 and the virtual objects 321 to 328 may be omitted. By reducing the number of displayed virtual objects, it becomes easier for the worker to check the information of the virtual objects 301 to 308. Instead of displaying the virtual objects 311 to 318 and the virtual objects 321 to 328, the virtual object 331 to 338 may be displayed. The virtual objects 331 to 338 are displayed between the fastening locations 201 to 208 and the virtual objects 301 to 308, respectively. The sizes of the virtual objects 331 to 338 are smaller than those of the virtual objects 321 to 328. In the illustrated example, the virtual objects 321 to 328 are rod-shaped, and the virtual objects 331 to 338 are linear. The virtual objects 331 to 338 are thinner than the virtual objects 321 to 328.

If the virtual objects 311 to 318 and the virtual objects 321 to 328 are displayed in the first mode, the display of the virtual objects 311 to 318 and the virtual objects 321 to 328 is omitted in the second mode. By displaying the virtual objects 331 to 338, the worker can easily understand the correspondence between the fastening locations 201 to 208 and the virtual objects 301 to 308. In addition, by displaying the virtual objects 331 to 338, which are more simplified than the virtual objects 321 to 328, the worker can more easily check the information of the virtual object 301 to 308.

If the virtual objects 311 to 318 and the virtual objects 321 to 328 are displayed in the first mode and the virtual objects 301 to 308 are away from the fastening locations 201 to 208, as shown in FIG. 27, the virtual objects 301 to 308 may be displayed near the fastening locations 201 to 208 in the second mode. For example, the distance between the fastening location 201 and the virtual object 301 in the second mode is shorter than the distance between the fastening location 201 and the virtual object 301 in the first mode. By moving the virtual objects 301 to 308 closer to the fastening locations 201 to 208, the number of displayed virtual objects can be reduced, and the correspondence between the fastening locations 201 to 208 and the virtual objects 301 to 308 can be easily understood by the worker.

FIG. 28 is a flowchart illustrating a processing method by the mixed reality device according to the embodiment.

In the processing method M3 shown in FIG. 28, first, the processing device 150 accepts the designation of the task to be performed (step S0). When accepting the designation, the processing device 150 reads the task data 171. The task data 171 includes a task ID, a task name, an article ID, and an article name. The processing device 150 can accept either the task ID, the task name, the article ID, or the article name as the specification of the task.

For example, the task may be selected by the worker or by a higher-level system. Based on data obtained from a sensor provided in the workplace or a reader provided in the workplace the processing device 150 may determine the task. The task may be automatically selected based on a schedule prepared in advance.

Thereafter, the processing device 150 executes the steps S1 to S5 in the same manner as the display control method M1 or M2. In the step S1, the processing device 150 reads the origin data 172. In the step S3, the processing device 150 reads the fastening location data 173.

The origin data 172 includes a method for identifying the origin. As the method for identifying the origin, a method using a marker or a method using a hand gesture is registered.

The fastening location data 173 includes the ID of each fastening location, the position of each fastening location, the angle of the extension bar, the model of the tool used, the required torque value, the required number of screw-tightening, the color of the mark, and the ID of each virtual object. The processing device 150 acquires data related to the task to be performed from the fastening location data 173.

The ID of the fastening location is unique identification information (character string) for identifying each fastening location. The positions of the fastening locations are registered as coordinates in the three-dimensional coordinate system based on the origin. The model of tool indicates the classification of the tool by structure, appearance, performance, etc. For example, the length of the extension bar is identified from the model of the extension bar. The angle indicates the limit value of the angle of the extension bar that can be fitted with the screw when the screw is turned to the fastening location.

During the task, a mark may be attached when the screw is turned to the fastening location. The “mark color” represents the color of the mark attached to each fastening location. If different colored marks are attached according to the number of times a screw is turned, the color of the mark for each count is registered. The virtual object ID is a character string for identifying the data of the pre-registered virtual object, and the virtual object ID is associated with each fastening location. The object shape is the shape of the displayed virtual object corresponding to each fastening location. The display mode is the color and size of the virtual object to be displayed.

After the step S5, the display direction control (step S10) shown in FIG. 8 and the display position control (step S20) shown in FIG. 19 are executed in parallel. After the steps S10 and S20, the processing device 150 determines whether a prescribed physical object (a hand or tool) comes into contact with any virtual object (step S31). When the prescribed physical object comes into contact with a virtual object, the processing device 150 estimates that the task is being performed to the fastening location corresponding to that virtual object (step S32). The processing device 150 stores a record of the task for the estimated location (step S33).

In the step S33, the processing device 150 associates the torque detected by the tool with the ID of the fastening location where the screw is estimated to be turned, and stores them in history data 174. As shown in FIG. 28, the processing device 150 may further associate the task ID, the model and ID of the tool used, the number of times the screw was tightened, and the recognition result of the mark with the ID of the fastening location. The mark is detected by the processing device 150 from an image captured by the image camera 131. The processing device 150 extracts a cluster of pixels of the pre-registered mark color from the image and counts the number of pixels in the cluster. When the number of pixels exceeds a preset threshold, it is determined that the mark has been attached.

After the step S33, the processing device 150 executes the step S6. Until the task is completed, the control of display direction, the control of display position, and the estimation of the location being worked on are repeatedly performed. The order of execution of the steps S10, S20, and S31 can be changed appropriately. The step S31 may be executed before the steps S10 and S20. The steps S10, S20, and S31 may be executed in parallel.

The task data 171, the origin data 172, the fastening location data 173, and the history data 174 are stored in the storage device 170 of the MR device 100. Alternatively, the task data 171, the origin data 172, the fastening location data 173, and the history data 174 may be stored in a storage area other than the MR device 100. In such a case, the processing device 150 accesses the task data 171, the origin data 172, the fastening location data 173, and the history data 174 via wireless communication or a network.

In the example, a case in which the embodiment is applied to the task of tightening the screw has been described. Embodiments of the present invention may be applied to the task of loosening the screw. When loosening the screw, as shown in FIG. 22, a tool is used and the screw is turned. In such a case, the virtual object is also displayed so that the task can be performed efficiently.

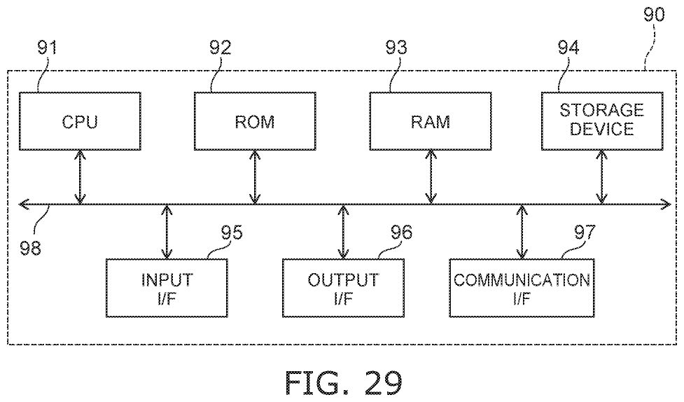

FIG. 29 is a schematic diagram illustrating a hardware configuration.

For example, a computer 90 shown in FIG. 29 is used as the processing device 150. The computer 90 includes a CPU 91, ROM 92, RAM 93, a storage device 94, an input interface 95, an output interface 96, and a communication interface 97.

The ROM 92 stores programs that control the tasks of the computer 90. Programs that are necessary for causing the computer 90 to realize the processing described above are stored in the ROM 92. The RAM 93 functions as a memory region into which the programs stored in the ROM 92 are loaded.

The CPU 91 includes a processing circuit. The CPU 91 uses the RAM 93 as working memory to execute the programs stored in at least one of the ROM 92 or the storage device 94. When executing the programs, the CPU 91 controls the various components via a system bus 98 and performs various processing.

The storage device 94 stores data necessary for executing the programs and data obtained by executing the programs. The storage device 94 includes a solid state drive (SSD), etc. The storage device 94 may be used as the storage device 170.

The input interface (I/F) 95 can connect the computer 90 to input devices. The CPU 91 can read various data from input devices via the input I/F 95. The output interface (I/F) 96 can connect the computer 90 and output devices. The CPU 91 can transmit data to output devices (e.g., projection devices 121 and 122) via the output I/F 96 and can cause the output device to display information.

The communication interface (I/F) 97 can connect the computer 90 and a device outside the computer 90. For example, the communication I/F 97 connects the digital tool and the computer 90 by Bluetooth (registered trademark) communication.

The data processing of the processing device 150 may be performed by only one computer 90. A portion of the data processing may be performed by a server or the like via the communication I/F 97.

The processing of the various data described above may be recorded, as a program that can be executed by a computer, in a magnetic disk (a flexible disk, a hard disk, etc.), an optical disk (CD-ROM, CD-R, CD-RW, DVD-ROM, DVD-R, DVD-RW, etc.), semiconductor memory, or another non-transitory computer-readable storage medium.

For example, the information that is recorded in the recording medium can be read by the computer (or an embedded system). The recording format (the storage format) of the recording medium is arbitrary. For example, the computer reads the program from the recording medium and causes a CPU to execute the instructions recited in the program based on the program. In the computer, the acquisition (or the reading) of the program may be performed via a network.

Embodiments of the present invention include the following features.

### Feature 1

A mixed reality device capable of superimposing a virtual space on a real space, configured to:
set a three-dimensional coordinate system in the virtual space based on a prescribed object imaged in the real space;
display a virtual object at a predetermined position in the three-dimensional coordinate system; and
change a display direction of the virtual object according to a positional relationship between the virtual object and the mixed reality device.

### Feature 2

The mixed reality device according to feature 1, wherein
the mixed reality device is configured to
   calculate a first vector along the display direction of the virtual object,
   calculate a second vector connecting a position of the virtual object and a position of the mixed reality device, and
   change the display direction of the virtual object according to an angle between the first vector and the second vector.

### Feature 3

The mixed reality device according to feature 2, wherein
the mixed reality device is configured to
   calculate a first angle between the first vector and the second vector in a first plane, the first plane being parallel to a first axis direction and a second axis direction of the three-dimensional coordinate system,
   calculate a second angle between the first vector and the second vector in a second plane, the second plane being perpendicular to the first plane and parallel to the first vector, and
   rotate the display direction of the virtual object by the first angle in the first plane and by the second angle in the second plane to change the display direction of the virtual object.

### Feature 4

The mixed reality device according to any one of features 1 to 3, wherein
the mixed reality device is configured to
   display a plurality of the virtual objects at a plurality of the predetermined positions in the three-dimensional coordinate system, respectively, and
   in a case where two or more of the plurality of virtual objects overlap, change a display position of at least one of the two or more virtual objects to reduce an overlap amount of the two or more virtual objects.

### Feature 5

The mixed reality device according to feature 4, wherein
the mixed reality device is configured to move one of the two or more virtual objects with respect to the other of the two or more virtual objects to reduce the overlap amount.

### Feature 6

The mixed reality device according to feature 4, wherein
the mixed reality device is configured to
   determine a priority of each of the two or more virtual objects, and
   move the virtual object with the lowest priority to reduce the overlap amount.

### Feature 7

The mixed reality device according to feature 4, wherein
the mixed reality device is configured to
   set a virtual surface in front of the plurality of virtual objects, and
   project the plurality of virtual objects onto the virtual surface to calculate the overlap amount.

### Feature 8

The mixed reality device according to feature 4, wherein
the mixed reality device is configured to differentiate a display of the virtual object that overlaps with a wearer's line of sight from a display of the other virtual objects among the plurality of virtual objects.

### Feature 9

The mixed reality device according to feature 4, wherein
the plurality of virtual objects are respectively displayed corresponding to a plurality of fastening locations in the real space where screws are turned.

### Feature 10

The mixed reality device according to feature 9, wherein
on each of the plurality of virtual objects, at least one selected from the group consisting of identification information of the corresponding fastening location, a torque value required for the corresponding fastening location, a torque value detected by a tool turning the screw, and a number of times the screw has been tightened for the corresponding fastening location is displayed.

### Feature 11

A mixed reality device capable of superimposing a virtual space on a real space, configured to:
set a three-dimensional coordinate system in the virtual space based on a prescribed physical object imaged in the real space;
display a plurality of virtual objects at a plurality of positions in the three-dimensional coordinate system, respectively; and
in a case where two or more of the plurality of virtual objects overlap, change a display position of at least one of the two or more virtual objects to reduce an overlap amount between the two or more virtual objects.

### Feature 12

The mixed reality device according to feature 11, wherein
the plurality of virtual objects are respectively displayed corresponding to a plurality of fastening locations in the real space where screws are turned.

### Feature 13

The mixed reality device according to feature 11 or 12, wherein
the mixed reality device is configured to move one of the two or more virtual objects with respect to the other of the two or more virtual objects to reduce the overlap amount.

### Feature 14

A display control method for a mixed reality device capable of superimposing a virtual space on a real space, comprising:
setting a three-dimensional coordinate system in the virtual space based on a prescribed physical object imaged in the real space;
displaying a virtual object at a predetermined position in the three-dimensional coordinate system; and
changing a display direction of the virtual object according to a positional relationship between the virtual object and the mixed reality device.

### Feature 15

A display control method for a mixed reality device capable of superimposing a virtual space on a real space, comprising:
setting a three-dimensional coordinate system in the virtual space based on a prescribed physical object imaged in the real space;
displaying a plurality of virtual objects at a plurality of positions in the three-dimensional coordinate system, respectively; and
in a case where two or more of the plurality of virtual objects overlap, changing a display position of at least one of the two or more virtual objects to reduce an overlap amount between the two or more virtual objects.

### Feature 16

A program causing a mixed reality device to execute the display control method according to feature 14 or 15.

### Feature 17

A non-transitory computer-readable storage medium storing the program according to feature 16.

As described above, examples in which each embodiment of the present invention is applied to a task have been described. Each embodiment can be applied to more than just tasks. That is, control of the display direction or display position can be applied to any virtual object. By applying the display direction or display position control to the virtual object displayed at a predetermined position in the real space, the virtual object becomes easier to see for the wearer of the MR device 100. According to each embodiment, the MR device 100 that is easy to use can be provided.

In the specification, “or” shows that “at least one” of items listed in the sentence can be adopted.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention. Moreover, above-mentioned embodiments can be combined mutually and can be carried out.

What is claimed is:

1. A mixed reality device capable of superimposing a virtual space on a real space, configured to:
set a three-dimensional coordinate system in the virtual space based on a prescribed object imaged in the real space;
display a virtual object at a predetermined position in the three-dimensional coordinate system; and
change a display direction of the virtual object according to a positional relationship between the virtual object and the mixed reality device.

2. The mixed reality device according to claim 1, wherein
the mixed reality device is configured to
calculate a first vector along the display direction of the virtual object,
calculate a second vector connecting a position of the virtual object and a position of the mixed reality device, and
change the display direction of the virtual object according to an angle between the first vector and the second vector.

3. The mixed reality device according to claim 2, wherein
the mixed reality device is configured to
calculate a first angle between the first vector and the second vector in a first plane, the first plane being parallel to a first axis direction and a second axis direction of the three-dimensional coordinate system,
calculate a second angle between the first vector and the second vector in a second plane, the second plane being perpendicular to the first plane and parallel to the first vector, and
rotate the display direction of the virtual object by the first angle in the first plane and by the second angle in the second plane to change the display direction of the virtual object.

4. The mixed reality device according to claim 1, wherein
the mixed reality device is configured to
display a plurality of the virtual objects at a plurality of the predetermined positions in the three-dimensional coordinate system, respectively, and
in a case where two or more of the plurality of virtual objects overlap, change a display position of at least one of the two or more virtual objects to reduce an overlap amount of the two or more virtual objects.

5. The mixed reality device according to claim 4, wherein
the mixed reality device is configured to move one of the two or more virtual objects with respect to the other of the two or more virtual objects to reduce the overlap amount.

6. The mixed reality device according to claim 4, wherein
the mixed reality device is configured to
determine a priority of each of the two or more virtual objects, and
move the virtual object with the lowest priority to reduce the overlap amount.

7. The mixed reality device according to claim 4, wherein
the mixed reality device is configured to
set a virtual surface in front of the plurality of virtual objects, and
project the plurality of virtual objects onto the virtual surface to calculate the overlap amount.

8. The mixed reality device according to claim 4, wherein
the mixed reality device is configured to differentiate a display of the virtual object that overlaps with a wearer's line of sight from a display of the other virtual objects among the plurality of virtual objects.

9. The mixed reality device according to claim 4, wherein
the plurality of virtual objects are respectively displayed corresponding to a plurality of fastening locations in the real space where screws are turned.

10. The mixed reality device according to claim 9, wherein
on each of the plurality of virtual objects, at least one selected from the group consisting of identification information of the corresponding fastening location, a torque value required for the corresponding fastening location, a torque value detected by a tool turning the screw, and a number of times the screw has been tightened for the corresponding fastening location is displayed.

11. A mixed reality device capable of superimposing a virtual space on a real space, configured to:
set a three-dimensional coordinate system in the virtual space based on a prescribed physical object imaged in the real space;
display a plurality of virtual objects at a plurality of positions in the three-dimensional coordinate system, respectively; and
in a case where two or more of the plurality of virtual objects overlap, change a display position of at least one of the two or more virtual objects to reduce an overlap amount between the two or more virtual objects.

12. The mixed reality device according to claim 11, wherein
the plurality of virtual objects are respectively displayed corresponding to a plurality of fastening locations in the real space where screws are turned.

13. The mixed reality device according to claim 11, wherein
the mixed reality device is configured to move one of the two or more virtual objects with respect to the other of the two or more virtual objects to reduce the overlap amount.

14. A display control method for a mixed reality device capable of superimposing a virtual space on a real space, comprising:
setting a three-dimensional coordinate system in the virtual space based on a prescribed physical object imaged in the real space;
displaying a virtual object at a predetermined position in the three-dimensional coordinate system; and
changing a display direction of the virtual object according to a positional relationship between the virtual object and the mixed reality device.

15. A non-transitory computer-readable storage medium storing a program for causing a mixed reality device to execute the display control method according to claim 14.
